(19) United States
(12) Patent Application Publication
(10) Pub. No.: US 2022/0249896 A1
(43) Pub. Date: Aug. 11, 2022

(54) Finger-assisted training device and application method thereof

(71) Applicant: The second affiliated Hospital and Yuying Children's Hospital of Wenzhou Medical University, Wenzhou (CN)

(72) Inventors: Sipin Zhu, Wenzhou (CN); Zhouguang Wang, Wenzhou (CN); Jiang Wu, Wenzhou (CN); Huacheng He, Wenzhou (CN); Xiangyang Wang, Wenzhou (CN); Wenfei Ni, Wenzhou (CN); Haicheng Dou, Wenzhou (CN); Sunren Sheng, Wenzhou (CN); Qishan Huang, Wenzhou (CN); Cong Xu, Wenzhou (CN)

(21) Appl. No.: 17/683,345

(22) Filed: Feb. 28, 2022

(30) Foreign Application Priority Data
Mar. 19, 2021 (CN) 202110297416.4

(51) Int. Cl. A63B 21/00; A63B 23/16; A61H 1/02

(52) U.S. Cl. CPC A63B 21/00181; A61H 2201/1207; A61H 1/0288; A63B 23/16

(57) ABSTRACT

A finger-assisted training device and an application method thereof are provided. An electric cylinder drives the sliding sleeve to slide; the sliding sleeve drives two connecting rod mechanisms; the connecting rod mechanism includes four connecting rod assemblies; the connecting rod assembly includes a rocker, a connecting rod and a movable rod; one end of the support is hinged on the support plate, the support is fixed on the support plate; the middle of the rocker is hinged with one end of the connecting rod, and the other end of the connecting rod is hinged with the sliding sleeve; the other end of the rocker is hinged with one end of the movable rod; the other end of the movable rod is fixed with a collar; the fixed arc rod is connected with the movable rod of each link assembly through a spring.

### CROSS REFERENCE OF RELATED APPLICATION

The present application claims priority under 35 U.S.C. 119(a-d) to CN 202110297416.4, filed Mar. 19, 2021.

### BACKGROUND OF THE PRESENT INVENTION

### Field of Invention

The present invention relates to the technical field of medical devices, and more particular to a finger-assisted training device and an application method thereof.

### Description of Related Arts

The health of hand function is an important factor affecting whether a person can live independently. Loss of part or all of the finger movement ability will make people unable to complete daily activities normally and reduce the quality of life of patients. Stroke, also known as cerebral apoplexy or cerebrovascular accident, is a sudden onset of cerebral blood circulation disorder, causing acute cerebral blood circulation disorder, clinically manifested as symptoms and signs of one-time or permanent brain dysfunction. Studies have shown that continuous high-intensity finger repetition training in stroke patients can help restore hand motor function. Traditional stroke treatment mainly relies on one-on-one hand-on-hand rehabilitation training between doctors, nurses or family members and patients, which is costly. Relying on the help of others also makes patients more passive in rehabilitation training, and cannot guarantee the intensity and effect of rehabilitation training Therefore, it is necessary to design a device for comprehensive and multi-modal rehabilitation training for the patient's fingers.

### SUMMARY OF THE PRESENT INVENTION

Accordingly, in view of the deficiencies in the conventional arts, an object of the present invention is to provide a finger-assisted training instrument and an application method thereof.

An finger-assisted training device comprises: a support plate, a sliding rod, an electric cylinder, a sliding sleeve and a link mechanism; wherein the support plate is fixed on the base through the support rod; wherein the finger-assisted training device further comprises a mounting block, a fixed arc rod, a support rod, spring and single-finger drive mechanism; wherein one end of the sliding rod is fixed on the support plate, and the mounting block is fixed on the other end of the sliding rod; the two sides of the mounting block are fixed with collars; the cylinder body of the electric cylinder is fixed on the support plate; the sliding sleeve and the sliding rod form a sliding pair, and are fixedly connected with the push rod of the electric cylinder through the connecting plate; the two link mechanisms are symmetrically arranged on both sides of the sliding rod; the link mechanism is composed of four connecting rod assemblies arranged at equal distances in the circumferential direction; the connecting rod assembly comprises a rocker, a connecting rod and a movable rod; one end of the rocker is hinged with the support, and the support is fixed on the support plate; the middle part of the rocker is hinged with one end of the connecting rod, and the other end of the connecting rod is hinged with the sliding sleeve; the other end of the rocker is hinged with one end of the movable rod, and the outer side of the hinged end of the rocker and the movable rod is provided with an integrally formed limit plate; the limit plate is parallel to the outer side of the rocker; the other end of the movable rod is fixed with a collar; in the initial state, the rocker is parallel to the movable rod, and the movable rod is set closer to the sliding rod than the rocker; the hinged connection between the movable rod and the rocker The end face is a circular arc surface, and the limit plate on the rocker is tangent to the circular arc surface and is set in close contact; in each link mechanism, the collars on the four movable rods are located on the same circumference, and the circumference and the mounting block are located on the same circle; the central axis of the collar on the corresponding side is coaxially arranged; the fixed arc rod is sleeved outside each connecting rod assembly, and is fixedly connected with the sliding rod through the support rod; the fixed arc rod is movable with each connecting rod assembly; the rod is connected by a spring; the single-finger drive mechanism comprises a rotary motor, a driving gear, a driven gear, a movable arc rod and a connecting rod; the housing of the rotary motor is fixed at the bottom of the mounting block; the driving gear is fixed with the output shaft of the rotary motor and meshes with the driven gear; the driven gear and the sliding rod form a rotating pair; the movable arc rod is located outside the connecting rod assembly and located inside the fixed arc rod; the movable arc-shaped rod and the driven gear are fixedly connected through a connecting rod; the connecting rod equally divides the movable arc-shaped rod into two rod segments; both ends of the inner side of the movable arc-shaped rod are fixed with a protrusion; the top is an arc surface, and the distance between the two ends of the arc surface is less than or equal to the width of the outer side of the movable rod; when the protrusion contacts the movable rod, a cam pair is formed, and each protrusion only contacts the movable rod corresponding to one link mechanism, and the two protrusions are not in contact with the movable rod at the same time.

Preferably, an arc length of the movable arc rod corresponding to the central angle is 110°; an arc length of the rod segment corresponding to the central angle is 55°; among the four link assemblies of the link mechanism, a central angle between two farthest link assemblies is 30°; and a central angle between the two link mechanisms is 150°.

Preferably, both the electric cylinder and the rotary motor are controlled by the controller.

Preferably, a pressure sensor is fixed in the collar, and the signal output end of the pressure sensor is connected to the controller.

A method for utilizing the finger-assisted training device comprises steps of: resetting both the electric cylinder and the rotating motor; wherein at this time, the distance between the collar on each movable rod and the collar on the mounting block is the largest, and the four movable rods of one link mechanism are all located on the same side as the movable arc rod, and are located at the same side as the movable arc rod; in the circumferential direction, they are located between the two protrusions on the movable arc rod, and the four movable rods of the other link mechanism are located on the opposite side of the movable arc rod; when the rotary motor is in the reset state, the push rod of the electric cylinder drives the sliding sleeve to slide back and forth on the sliding rod via the connecting plate; the sliding sleeve drives each rocker to swing reciprocally through each link, and each rocker drives each movable rod to reciprocate, so that the collar on each movable rod corresponds to the installation block; the collars on the side move closer to or separate from each other; among them, when the sliding sleeve slides outward on the sliding rod, each connecting rod drives each rocker to move closer inward, and combined with the pulling force of the spring and the limiting effect of the limiting plate, each rocking The rod then drives each movable rod to move inward; when the sliding sleeve slides inward on the sliding rod to reset, each connecting rod drives each rocker to separate outward, and each movable rod acts on the restoring force of the corresponding spring and the limiting effect of the limit plate; when the electric cylinder is in the reset state and the rotating motor rotates in the forward direction, the driving gear rotates in the forward direction, the driven gear meshes with the driving gear and drives the connecting rod to rotate in the opposite direction to the rotating motor, and the connecting rod drives the moving arc rod to turn to the link mechanism on the other side, so that each movable rod in the two link mechanisms swings back and forth in sequence according to the direction opposite to the rotation of the rotating motor, so that the collar on each movable rod performs one operation in turn with the installation block; the action of the rings on the corresponding side approaching and separating from each other; when the electric cylinder is in the reset state and the rotating motor rotates in the reverse direction, the driving gear is driven to rotate in the reverse direction; the direction of rotation is rotated, and the connecting rod drives the movable arc rod to turn to the initial position, so that each movable rod in the two link mechanisms swings back and forth in sequence in the direction opposite to the rotation of the rotating motor, so that the collars on each movable rod are executed one time in turn; the action of approaching and separating from the collar on the corresponding side of the mounting block; wherein during the rotation of the movable arc rod, after one protrusion is in contact with the movable rod corresponding to one link mechanism, the other protrusion is not connected to the other; the movable rod of the link mechanism is in contact with the movable rod; when the protrusion is in contact with the movable rod, press the end of the movable rod with the collar fixed to the sliding rod, the protrusion is separated from the movable rod, the movable rod is reset under the action of the restoring force and limit of the limit plate.

The beneficial effects of the present invention are as follows.

1. The present invention can perform synchronous closing training for the fingers of the whole hand, and can also train the fingers one by one, one-hand training can be performed, and both hands can be trained at the same time, and an electric mode can be used to perform auxiliary training on the fingers, In the later stage of recovery, when the fingers slowly regain their strength, the fingers can be used for manual weight-bearing exercise, and the movable rod can be retracted by the finger strength to achieve autonomous recovery training; The range is reciprocating forward and reverse, and the repeated closing and separating training of any finger can also be realized; it can be seen that the present invention has a variety of training modes, so that the training is not single, and has the characteristics of step-by-step advancement.

2. The present invention can perform manual exercise with different weights by replacing springs with different thicknesses; during manual weight-bearing exercise, the pressure sensor arranged in the collar can accurately detect the strength achieved when the corresponding fingers are folded, and help patients understand their own recovery. And adjust the intensity of rehabilitation training in time according to the recovery situation (replace springs with different thicknesses), thereby effectively preventing the stiffness of the patient's finger joints, promoting the patient's blood circulation, stimulating the patient's hand nerves, and helping them restore some motor functions.

3. The collar of the present invention is made of silicone material, and fingers of different thicknesses can be well fitted and used, which can prevent the fingers from detaching during the movement process, and can also avoid the phenomenon of pain caused by friction between the fingers and the hard material.

4. The present invention is simple in structure and simple in control, and realizes the arbitrary switching of the training mode of synchronously closing the fingers of the whole hand or the training mode of each finger one by one through two powers, especially the mode of training each finger one by one. Momentum is realized.

### BRIEF DESCRIPTION OF THE DRAWINGS

FIG. 1 is a perspective view of an overall structure of the present invention.

FIG. 2 is another perspective view of the overall structure of the present invention.

FIG. 3 is an assembly perspective view of a sliding sleeve, a link mechanism, a driving gear, a driven gear, a movable arc rod and a connecting rod in the present invention.

In the drawings: 1—support plate, 2—base, 3—support rod, 4—slide rod, 5—slide sleeve, 6—electric cylinder, 7—connecting plate, 8—support, 9—rocker, 9-1—limit plate, 10—connecting rod, 11—spring, 12—fixed arc rod, 13—moving arc rod, 14—rotating motor, 15—driven gear, 16—movable rod, 17—driving gear.

### DETAILED DESCRIPTION OF THE PREFERRED EMBODIMENT

The present invention will be further described below with reference to the accompanying drawings.

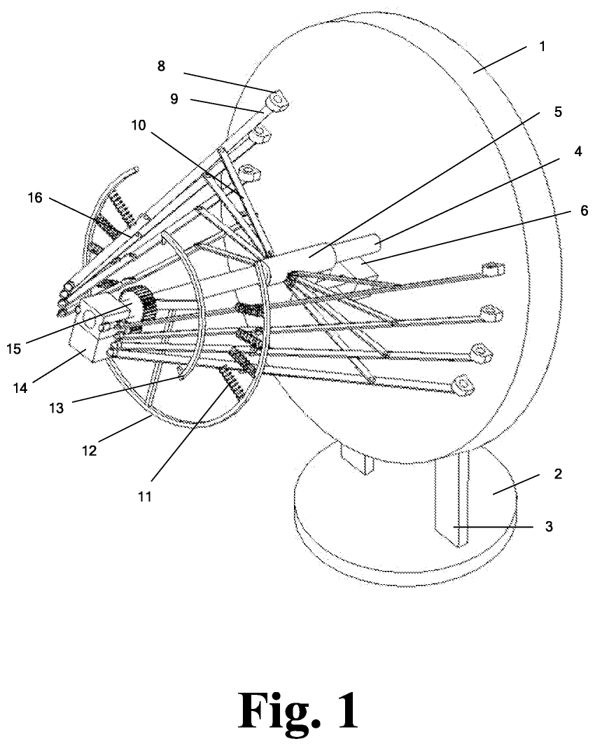

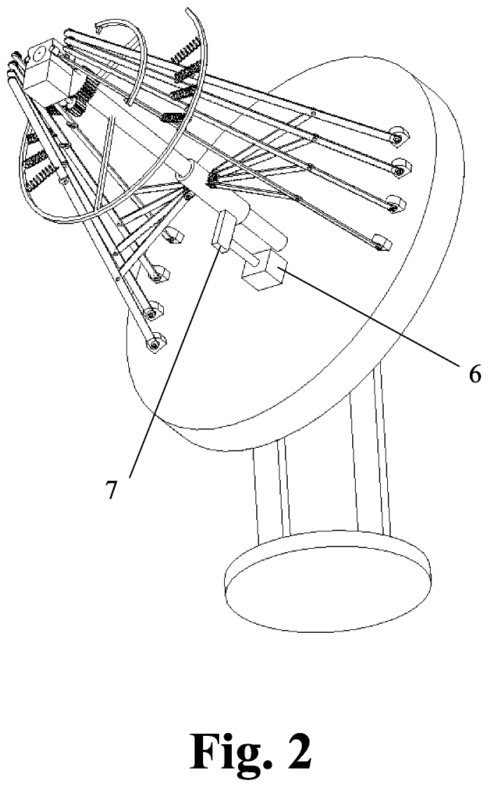

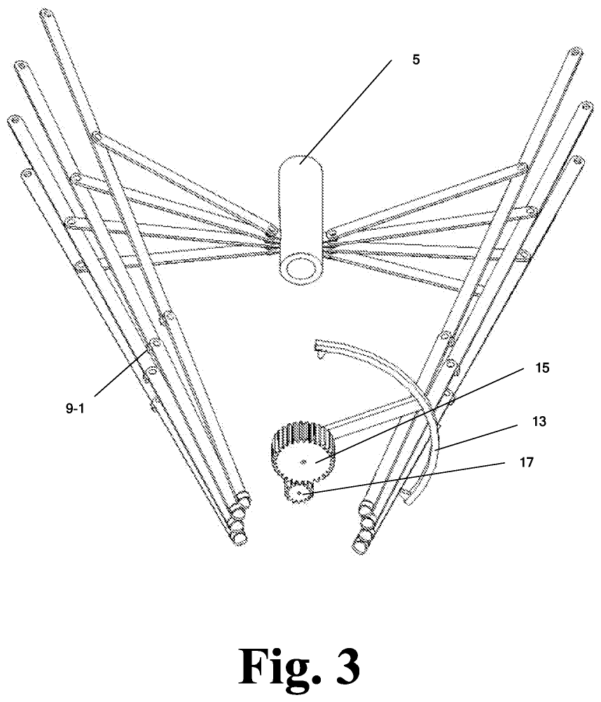

As shown in FIGS. 1, 2 and 3, the auxiliary finger training device comprises a support plate 1, a sliding rod 4, an electric cylinder 6, a sliding sleeve 5, a link mechanism, a mounting block, a fixed arc rod 12, a support rod, and a spring 11 and the single-finger drive mechanism; wherein the support plate 1 is fixed on the base 2 through the support rod 3; one end of the sliding rod 4 is fixed on the support plate 1, and the mounting block is fixed on the other end of the sliding rod; the two sides of the mounting block are fixed with sleeves. The cylinder body of the electric cylinder 6 is fixed on the support plate 1; the sliding sleeve 5 and the sliding rod 4 form a sliding pair, and are fixedly connected with the push rod of the electric cylinder 6 through the connecting plate 7; the two sides of the rod 4; the link mechanism is composed of four link assemblies arranged at equal distances in the circumferential direction; the link assembly includes a rocker 9, a link 10 and a movable rod 16; one end of the rocker 9 is hinged with the support 8, the support 8 is fixed on the support plate 1; the middle part of the rocker 9 is hinged with one end of the connecting rod 10, the other end of the connecting rod 10 is hinged with the sliding sleeve 5; the other end of the rocker 9 is hinged with one end of the movable rod 16, and the outer side of the hinged end of the rocker 9 and the movable rod 16 is provided with an integrally formed limit plate 9-1; the limit plate 9-1 is parallel to the outer side of the rocker 9; the other end of the movable rod 16 is fixed with a collar; In the initial state, the rocker 9 is parallel to the movable rod 16, and the movable rod 16 is set closer to the sliding rod 4 than the rocker 9; The plate 9-1 is tangent to the arc surface and is arranged in close contact; in each link mechanism, the collars on the four movable rods 16 are located on the same circumference, and the circumference is the same as the central axis of the collar on the corresponding side of the mounting block. The shaft is arranged; the fixed arc rod 12 is sleeved outside each connecting rod assembly, and is fixedly connected with the sliding rod 4 through the support rod; the fixed arc rod 12 is connected with the movable rod of each connecting rod assembly through a spring 11; Refers to the drive mechanism including the rotary motor 14, the driving gear 17, the driven gear 15, the movable arc rod 13 and the connecting rod; the housing of the rotary motor 14 is fixed at the bottom of the mounting block; the driving gear 17 is fixed with the output shaft of the rotary motor 14, and meshes with the driven gear 15; the driven gear 15 and the sliding rod 4 constitute a rotating pair; the movable arc rod 13 is located outside the connecting rod assembly and is located inside the fixed arc rod 12; the movable arc rod 13 and the driven gear 15. It is fixedly connected by a connecting rod; the connecting rod divides the movable arc rod 13 into two rod segments equally; both ends of the inner side of the movable arc rod 13 are fixed with a protrusion; the top of the protrusion is an arc surface, and the two arc surfaces are The distance between the ends is less than or equal to the width of the outer side of the movable rod 16; when the protrusions are in contact with the movable rod 16, a cam pair is formed, each protrusion only contacts with the movable rod 16 corresponding to one link mechanism, and the two protrusions are not in contact with the movable rod 16 at the same time.

As a preferred embodiment, the design scheme in which each protrusion only contacts the movable rod 16 corresponding to one link mechanism and the two protrusions do not contact the movable rod 16 at the same time is as follows: the arc length of the movable arc rod 13 corresponds to the central angle of the circle It is 110°, the arc length of the rod segment corresponds to the central angle of 55°, the central angle between the two link assemblies farthest apart among the four link assemblies of the link mechanism is 30°, and the two link members on both sides of the link mechanism are included. The central angles of the included circles are all 150°, so that each protrusion can only be in contact with the movable rod 16 corresponding to a link mechanism during the rotation of the movable arc rod 13, and when a protrusion is in contact with the movement of a corresponding link mechanism. When the rod 16 is completely contacted, the other protrusion will come into contact with the movable rod 16 of the other link mechanism.

As a preferred embodiment, both the electric cylinder 6 and the rotary electric machine 14 are controlled by the controller.

As a preferred embodiment, a pressure sensor is fixed in the collar, and the signal output end of the pressure sensor is connected to the controller.

A method for applying the finger-assisted training device is as follows.

Both the electric cylinder 6 and the rotary motor 14 are reset. At this time, the distance between the collar on each movable rod 16 and the collar on the mounting block is the largest, and the four movable rods 16 of one link mechanism are located at the movable arc rod 13. On the same side, and in the circumferential direction, they are located between the two protrusions on the movable arc rod 13, and the four movable rods 16 of the other link mechanism are all located on the opposite side of the movable arc rod 13. When the rotary motor 14 is in the reset state, and the push rod of the electric cylinder 6 drives the sliding sleeve 5 to slide back and forth on the sliding rod 4 through the connecting plate 7, the sliding sleeve 5 drives the rocker 9 to swing back and forth through the connecting rods 10, and each rocker 9 Then drive each movable rod 16 to swing back and forth, so that the collar on each movable rod 16 and the collar on the corresponding side of the mounting block are moved closer to or apart from each other (if the thumbs of both hands are placed on the two collars of the mounting block) Inside, the remaining four fingers of one hand are set in the collars on the four movable rods 16 on the corresponding side, and the remaining four fingers of the other hand are set in the collars on the four movable rods 16 on the other side. When the sliding sleeve 5 slides outward on the sliding rod 4, each connecting rod 10 drives each rocking rod 9 to move inwardly, and combined with the pulling force of the spring 11 and the limiting action of the limit plate 9-1, each rocker 9 drives each movable rod 16 to move inward; when the sliding sleeve 5 slides inward on the sliding rod 4 and resets, each link 10 drives each rocker 9 to separate outward, and each movable rod 16 is reset under the restoring force of the corresponding spring and the limiting action of the limiting plate 9-1. When the electric cylinder 6 is in the reset state and the rotary motor 14 rotates in the forward direction, the driving gear 17 is driven to rotate in the forward direction, and the driven gear 15 meshes with the driving gear 17 to drive the connecting rod to rotate in the opposite direction to the rotation of the rotary motor 14. The connecting rod drives The movable arc-shaped rod 13 turns to the link mechanism on the other side, so that each movable rod 16 in the two link mechanisms swings back and forth in sequence according to the direction opposite to the rotation of the rotating motor 14, so that the collar on each movable rod 16 Perform the action of approaching and separating the rings on the corresponding side of the mounting block in sequence (if the thumbs of two hands are put into the two rings of the mounting block, the other four fingers of one hand are put on the corresponding one. In the loops on the four movable rods 16 on the side, the other four fingers of the other hand are placed in the loops on the four movable rods 16 on the other side, then the thumbs of both hands are not moved, and the two The remaining eight fingers of the hand move toward or separate from their corresponding thumbs in sequence); when the electric cylinder 6 is in the reset state and the rotary motor 14 rotates in the reverse direction, the driving gear 17 is driven to rotate in the reverse direction, and the driven gear 15 and The engagement of the driving gear 17 drives the connecting rod to rotate in the opposite direction to the rotation of the rotary motor 14, and the connecting rod drives the movable arc rod 13 to turn to the initial position, so that each movable rod 16 in the two link mechanisms rotates in the opposite direction to the rotation of the rotary motor 14. The sequence swings back and forth one time in sequence, so that the collars on each movable rod 16 move toward and separate from the collars on the corresponding sides of the mounting block in turn; After the movable rod 16 corresponding to one link mechanism is in contact, the other protrusion contacts the movable rod 16 of the other link mechanism. When the protrusion contacts the movable rod 16, the end of the movable rod 16 fixed with the collar is pressed. To the sliding rod 4 (at this time, the end of the movable rod 16 with the arc surface can be rotated on the limit plate 9-1, and the swing of the movable rod 16 is not restricted), after the protrusion is separated from the movable rod 16, the movable rod 16 moves. The rod 16 is reset under the restoring force and the limiting action of the limiting plate 9-1.

In addition to using the electric mode for auxiliary training of the fingers, the finger auxiliary training instrument of the present invention can also perform manual weight-bearing exercise for the fingers under the reset state of the electric cylinder 6 and the rotating motor 14 (applicable to the later stage of recovery, when the fingers have a certain strength); during manual weight-bearing exercise of the fingers, the electric cylinder 6 and the rotary motor 14 do not move, the thumb is set in the collar of the mounting block, and the other four fingers are set in the collar on the four movable rods 16 on the corresponding side. The force of the fingers overcomes the force of the spring to press the end of the movable rod 16 with the collar fixed to the sliding rod 4, so as to realize the action of folding the fingers and achieve the effect of weight-bearing exercise, and there is a pressure sensor in each collar to detect the corresponding finger. The controller can number each pressure sensor and display the detection value of each pressure sensor on the display to monitor the recovery process; while the fingers are opened, there is a spring assist. The present invention can be used for auxiliary training of fingers in electric mode or manual weight-bearing exercise of fingers, and can be trained with one hand or with both hands at the same time.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An finger-assisted training device comprising: a support plate, a sliding rod, an electric cylinder, a sliding sleeve and a link mechanism; wherein the support plate is fixed on the base through the support rod; wherein the finger-assisted training device further comprises a mounting block, a fixed arc rod, a support rod, spring and single-finger drive mechanism; wherein one end of the sliding rod is fixed on the support plate, and the mounting block is fixed on the other end of the sliding rod; the two sides of the mounting block are fixed with collars; the cylinder body of the electric cylinder is fixed on the support plate; the sliding sleeve and the sliding rod form a sliding pair, and are fixedly connected with the push rod of the electric cylinder through the connecting plate; the two link mechanisms are symmetrically arranged on both sides of the sliding rod; the link mechanism is composed of four connecting rod assemblies arranged at equal distances in the circumferential direction; the connecting rod assembly comprises a rocker, a connecting rod and a movable rod; one end of the rocker is hinged with the support, and the support is fixed on the support plate; the middle part of the rocker is hinged with one end of the connecting rod, and the other end of the connecting rod is hinged with the sliding sleeve; the other end of the rocker is hinged with one end of the movable rod, and the outer side of the hinged end of the rocker and the movable rod is provided with an integrally formed limit plate; the limit plate is parallel to the outer side of the rocker; the other end of the movable rod is fixed with a collar; in the initial state, the rocker is parallel to the movable rod, and the movable rod is set closer to the sliding rod than the rocker; the hinged connection between the movable rod and the rocker The end face is a circular arc surface, and the limit plate on the rocker is tangent to the circular arc surface and is set in close contact; in each link mechanism, the collars on the four movable rods are located on the same circumference, and the circumference and the mounting block are located on the same circle; the central axis of the collar on the corresponding side is coaxially arranged; the fixed arc rod is sleeved outside each connecting rod assembly, and is fixedly connected with the sliding rod through the support rod; the fixed arc rod is movable with each connecting rod assembly; the rod is connected by a spring; the single-finger drive mechanism comprises a rotary motor, a driving gear, a driven gear, a movable arc rod and a connecting rod; the housing of the rotary motor is fixed at the bottom of the mounting block; the driving gear is fixed with the output shaft of the rotary motor and meshes with the driven gear; the driven gear and the sliding rod form a rotating pair; the movable arc rod is located outside the connecting rod assembly and located inside the fixed arc rod; the movable arc-shaped rod and the driven gear are fixedly connected through a connecting rod; the connecting rod equally divides the movable arc-shaped rod into two rod segments; both ends of the inner side of the movable arc-shaped rod are fixed with a protrusion; the top is an arc surface, and the distance between the two ends of the arc surface is less than or equal to the width of the outer side of the movable rod; when the protrusion contacts the movable rod, a cam pair is formed, and each protrusion only contacts the movable rod corresponding to one link mechanism, and the two protrusions are not in contact with the movable rod at the same time.

2. The finger-assisted training device, as recited in claim 1, wherein an arc length of the movable arc rod corresponding to the central angle is 110°; an arc length of the rod segment corresponding to the central angle is 55°; among the four link assemblies of the link mechanism, a central angle between two farthest link assemblies is 30°; and a central angle between the two link mechanisms is 150°.

3. The finger-assisted training device, as recited in claim 1, wherein both the electric cylinder and the rotary motor are controlled by the controller.

4. The finger-assisted training device, as recited in claim 1, wherein a pressure sensor is fixed in the collar, and the signal output end of the pressure sensor is connected to the controller.

5. A method for utilizing the finger-assisted training device, as recited in claim 1, comprising steps of: resetting both the electric cylinder and the rotating motor; wherein at this time, the distance between the collar on each movable rod and the collar on the mounting block is the largest, and the four movable rods of one link mechanism are all located on the same side as the movable arc rod, and are located at the same side as the movable arc rod; in the circumferential direction, they are located between the two protrusions on the movable arc rod, and the four movable rods of the other link mechanism are located on the opposite side of the movable arc rod; when the rotary motor is in the reset state, the push rod of the electric cylinder drives the sliding sleeve to slide back and forth on the sliding rod via the connecting plate; the sliding sleeve drives each rocker to swing reciprocally through each link, and each rocker drives each movable rod to reciprocate, so that the collar on each movable rod corresponds to the installation block; the collars on the side move closer to or separate from each other; among them, when the sliding sleeve slides outward on the sliding rod, each connecting rod drives each rocker to move closer inward, and combined with the pulling force of the spring and the limiting effect of the limiting plate, each rocking The rod then drives each movable rod to move inward; when the sliding sleeve slides inward on the sliding rod to reset, each connecting rod drives each rocker to separate outward, and each movable rod acts on the restoring force of the corresponding spring and the limiting effect of the limit plate; when the electric cylinder is in the reset state and the rotating motor rotates in the forward direction, the driving gear rotates in the forward direction, the driven gear meshes with the driving gear and drives the connecting rod to rotate in the opposite direction to the rotating motor, and the connecting rod drives the moving arc rod to turn to the link mechanism on the other side, so that each movable rod in the two link mechanisms swings back and forth in sequence according to the direction opposite to the rotation of the rotating motor, so that the collar on each movable rod performs one operation in turn with the installation block; the action of the rings on the corresponding side approaching and separating from each other; when the electric cylinder is in the reset state and the rotating motor rotates in the reverse direction, the driving gear is driven to rotate in the reverse direction; the direction of rotation is rotated, and the connecting rod drives the movable arc rod to turn to the initial position, so that each movable rod in the two link mechanisms swings back and forth in sequence in the direction opposite to the rotation of the rotating motor, so that the collars on each movable rod are executed one time in turn; the action of approaching and separating from the collar on the corresponding side of the mounting block; wherein during the rotation of the movable arc rod, after one protrusion is in contact with the movable rod corresponding to one link mechanism, the other protrusion is not connected to the other; the movable rod of the link mechanism is in contact with the movable rod; when the protrusion is in contact with the movable rod, press the end of the movable rod with the collar fixed to the sliding rod, the protrusion is separated from the movable rod, the movable rod is reset under the action of the restoring force and limit of the limit plate.
